(19) United States
(12) Patent Application Publication
(10) Pub. No.: US 2025/0389946 A1
(43) Pub. Date: Dec. 25, 2025

(54) JEWELRY LOUPE

(71) Applicant: Shenzhen Dikai Industrial Co., Ltd, Shenzhen City (CN)

(72) Inventors: XIULING ZHU, Shenzhen (CN); XIANNIAN ZHU, Shenzhen (CN)

(73) Assignee: Shenzhen Dikai Industrial Co., Ltd, Shenzhen City (CN)

(21) Appl. No.: 18/976,270

(22) Filed: Dec. 10, 2024

(30) Foreign Application Priority Data
Jun. 20, 2024 (CN) 202410797900.7

(51) Int. Cl. G02B 25/00

(52) U.S. Cl. CPC G02B 25/002

(57) ABSTRACT

A jewelry magnifier includes a holder and a magnifier assembly rotatably stored in the holder. The holder includes an upper cover and a lower cover. The upper and lower covers are tightly fitted and mounted by a connecting post and a rotating shaft. The magnifier assembly includes a lens and a lens frame. A rotating shaft cavity is formed in the lens frame. The rotating shaft is mounted in the rotating shaft cavity to enable the magnifier assembly to be rotatably connected to the holder and buckled against the connecting post. The lens frame includes an accommodating cavity surrounding the rotating shaft, and at least one damping member is disposed in the accommodating cavity to generate rotating damping between the damping member and the rotating shaft due to interference. The lens frame controls folding and rotating damping by a friction force between the damping member and the rotating shaft.

### TECHNICAL FIELD

The present invention relates to the technical field of microscopes, and in particular to a jewelry magnifier.

### BACKGROUND ART

In jewelry appraisal, a magnifier is used commonly in order to observe jewelry more clearly.

A folding rotating shaft, which is used for a folding-type jewelry magnifier in the prior art, comprises two basic connection forms, namely rivet connection and screw-fixation connection. The existing folding-type jewelry magnifiers using the above fixation methods will have the location of a rivet or a screw observable in appearance; however, the folding connection methods in the two forms of rivet and screw fixation both have the problem of loosening, and a structure assembled by using a rivet cannot be recovered after it becomes loosened. In addition, due to insufficient flatness and smoothness, the magnifier product also has the problem of a poor hand feeling during use.

In the prior art, when a folding holder is prepared for a folding-type jewelry magnifier, according to the designed folding tightness, it is necessary to press a rivet for riveting by relying on a press device or directly rotate a screw and a hole site to adjust the folding tightness. The tightness of the above machined folding connection structure cannot be accurately controlled and is very unreliable, and the tightness is the source of the damping feeling; as for external manifestation, looseness occurs after folding for hundreds of times, and in the case of using the rivet as a connecting piece, such looseness cannot be recovered.

In addition, the magnifiers in a rivet connection and a screw-fixation connection will also have some parts of the screws or rivets remained in their appearance, resulting in a less beautiful design.

### SUMMARY OF THE INVENTION

Based on this, in order to solve the above-mentioned problems in the traditional technology, the present invention proposes a jewelry magnifier, which has a more beautiful design, provides a better hand feeling during use, controls folding and rotating damping by a friction force between a damping member and a rotating shaft without affecting a damping feeling after folding for tens of thousands of times, and is unloosened and durable.

The present invention relates to a jewelry magnifier, comprising a holder and a magnifier assembly rotatably stored in the holder, wherein the holder comprises an upper cover and a lower cover, and the upper cover and the lower cover are tightly fitted and mounted by a connecting post and a rotating shaft; and the magnifier assembly comprises a lens and a lens frame, a rotating shaft cavity is formed in the lens frame, the rotating shaft is accommodated and mounted in the rotating shaft cavity so as to enable the magnifier assembly to be rotatably connected to the holder and buckled against the connecting post, the lens frame is provided with an accommodating cavity surrounding the rotating shaft, and at least one damping member is disposed in the accommodating cavity to generate required rotating damping between the damping member and the rotating shaft due to interference.

In a bearing tight-fit design, the upper cover is provided with a first shaft post and a third shaft post, and the lower cover is provided with a second shaft post and a fourth shaft post; the third shaft post is provided with a third interference hole, and the fourth shaft post is provided with a fourth interference hole, wherein the rotating shaft passes through the rotating shaft cavity with one end thereof mounted in the third interference hole in an interference fit manner and the other end mounted in the fourth interference hole in the interference fit manner.

During implementation, the lens frame comprises a first sheet body and a second sheet body, the rotating shaft cavity comprises an upper rotating shaft cavity and a lower rotating shaft cavity communicated with each other, and the accommodating cavity comprises an upper chamber and a lower chamber communicated with each other, wherein the first sheet body is provided with a first lens window, the lower rotating shaft cavity, and the lower chamber, and the second sheet body is provided with a second lens window, the upper chamber, and the upper rotating shaft cavity.

For a lighter and smaller structural design, one end of the rotating shaft and the third shaft post in interference fit are jointly mounted in the upper rotating shaft cavity, and the other end of the rotating shaft and the fourth shaft post in the interference fit are together mounted in the lower rotating shaft cavity.

In a damping rotation design, at least one of the upper chamber or the lower chamber of the accommodating cavity is equipped with two or more damping members; or both the upper chamber and the lower chamber are equipped with two or more damping members, wherein the damping members are rubber rings.

The first sheet body is provided with an outer positioning edge at the top of the first lens window, the second sheet body is provided with an inner positioning edge at the bottom of the second lens window, and the inner positioning edge and the outer positioning edge engage with each other.

In order to fix and protect the lens, the lens is a three-layer cemented lens, the first sheet body is provided with a lower limiting shoulder at a bottom edge of the first lens window, and a first vibration-attenuating ring is disposed between the three-layer cemented lens and the lower limiting shoulder; and the second sheet body is provided with an upper limiting shoulder at a top edge of the second lens window, and a second vibration-attenuating ring is disposed between the three-layer cemented lens and the upper limiting shoulder.

Further, the connecting post is provided with a first interference hole at the top and a second interference hole at the bottom, and the connecting shaft is mounted together with the first shaft post of the upper cover in the interference fit manner through the first interference hole and is mounted together with the second shaft post of the lower cover in the interference fit manner through the second interference hole.

A clamping projection is provided on an outer wall of the lens frame, and when the magnifier assembly is folded, the clamping projection is clamped and fixed with the connecting post; and the clamping projection extends from the first sheet body to the second sheet body.

Preferably, a through hole for a lanyard to pass through is provided in the connecting post.

The damping member such as a rubber ring or a rubber pad is used for the jewelry magnifier of the present invention, so as to create a rotating damping feeling by interference. When the magnifier assembly is rotated out from or into the holder, the damping for folding and rotating control is generated between the damping member and the rotating shaft due to the friction force, to ensure that the magnifier assembly can be folded tens of thousands of times without affecting the damping feeling while remaining unloosened, thus achieving durability and a better hand feeling during use.

The jewelry magnifier of the present invention doesn't have a rivet, a screw, or other rotating shaft fixing components on the upper and lower surfaces of the lens holder, such that the upper cover and the lower cover are assembled by using a bearing tight-fit structure, and the jewelry magnifier overall has flat and smooth surfaces and a beautiful design.

### BRIEF DESCRIPTION OF THE DRAWINGS

In order to describe the technical solution in the embodiment of the present invention or in the prior art more clearly, the accompanying drawings that need to be used in the description of the embodiment or the prior art will be briefly introduced below. Apparently, the accompanying drawings described below are only some of the embodiments of the present invention, and other drawings may further be obtained by those of ordinary skill in the art according to these accompanying drawings without any inventive work.

Wherein:

FIG. 1 is a three-dimensional structural schematic diagram of a jewelry magnifier with a gear box rotated out according to the embodiment;

FIG. 2 is a lateral structural schematic diagram of a jewelry magnifier with a gear box rotated in according to the embodiment;

FIG. 3 is a three-dimensional structural diagram of a jewelry magnifier without a diamond clip inserted according to the embodiment;

FIG. 4 is a three-dimensional structural diagram of a jewelry magnifier loaded with a diamond clip according to the embodiment; and

FIG. 5 is a three-dimensional exploded mechanism diagram of a jewelry magnifier according to the embodiment.

### DETAILED DESCRIPTION OF EMBODIMENTS

The technical solutions in the embodiments of the present invention will be clearly and completely described below in conjunction with the accompanying drawings in the embodiments of the present invention, and it is obvious that the described embodiments are only some of the embodiments of the present invention, rather than all of the embodiments. Based on the embodiments in the present invention, all other embodiments obtained by those of ordinary skill in the art without any inventive work fall within the scope of protection of the present invention.

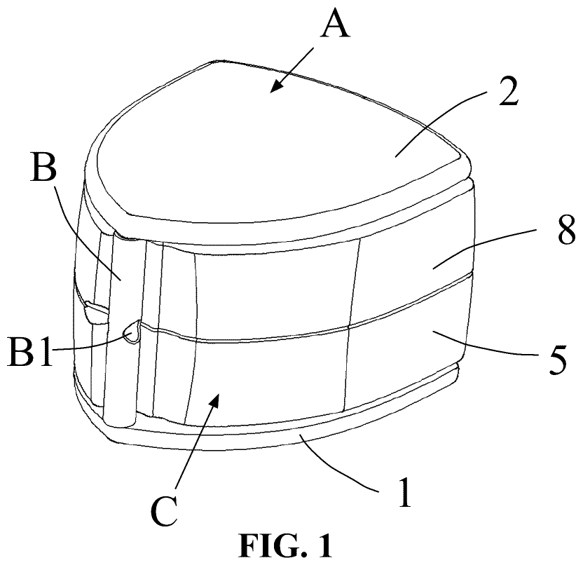

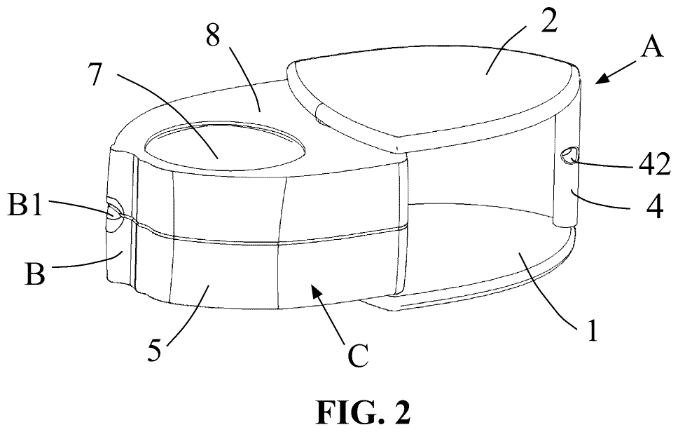

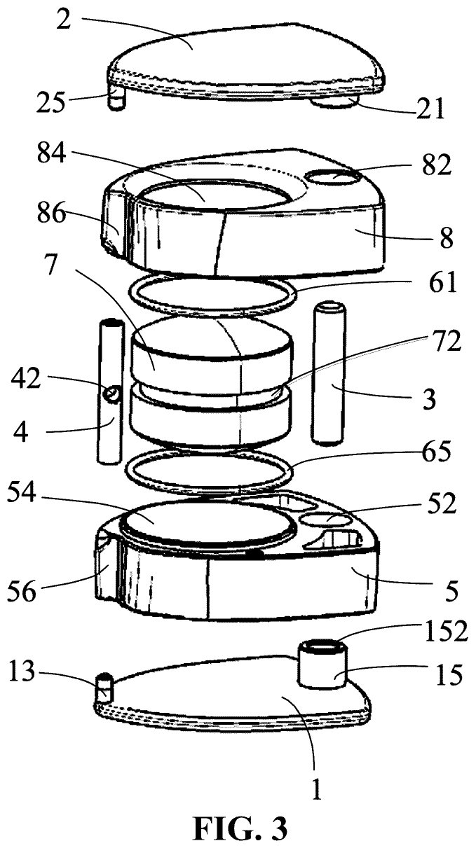

As shown in FIG. 1, FIG. 2, and FIG. 3, the jewelry magnifier of the embodiment comprises a holder A and a magnifier assembly C rotatably stored in the holder A.

The holder A comprises an upper cover 2 and a lower cover 1. The upper cover 2 and the lower cover 1 are tightly fitted and mounted by a connecting post 4 and a rotating shaft 3.

The magnifier assembly C comprises a lens 7 and a lens frame for storing and mounting the lens 7. The lens frame is an up-down structure with a rotating shaft cavity C1 formed on one side, wherein the rotating shaft 3 is accommodated and mounted in the rotating shaft cavity C1. The magnifier assembly C is rotatably connected to the holder A by the rotating shaft 3. When the magnifier assembly C is folded and put into the holder A, it can be buckled against the connecting post 4 to be tightly locked.

The lens frame is provided with an accommodating cavity C2 surrounding the rotating shaft 3, and the accommodating cavity C2 is communicated with the rotating shaft cavity C1. At least one damping member, such as a rubber ring or a rubber pad, is disposed in the accommodating cavity C2 to generate the required rotating damping between the damping member and the rotating shaft 3 due to interference. In the embodiment, the rubber rings 91 and 94 are taken as examples for explanation.

The lens frame with the up-down structure comprises a first sheet body 8 and a second sheet body 5 that are buckled up and down to form a lens cavity and the rotating shaft cavity.

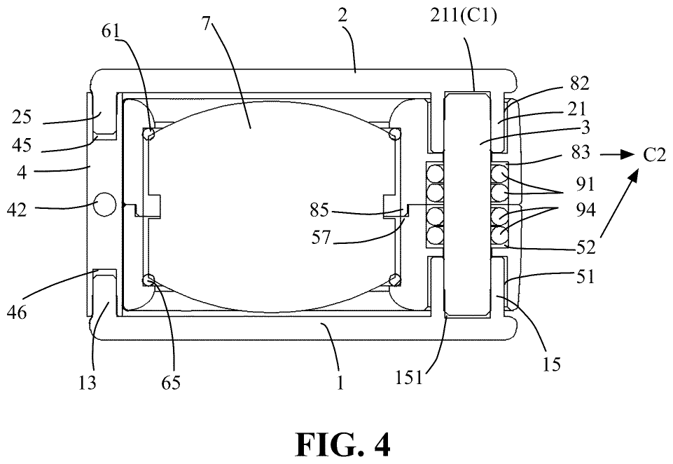

Referring to FIG. 4 as well, the rotating shaft cavity C1 comprises an upper rotating shaft cavity 82 formed at the first sheet body 5 and a lower rotating shaft cavity 51 formed at the second sheet body 5, which are communicated with each other.

The accommodating cavity comprises an upper chamber 83 and a lower chamber 52 which are communicated with each other.

The first sheet body 5 is provided with a first lens window 54, the lower rotating shaft cavity 51, and the lower chamber 52. The lower rotating shaft cavity 51 and the lower chamber 52 are separated by a partition, and both the lower rotating shaft cavity 51 and the lower chamber 52 are communicated with the rotating shaft cavity C1. The second sheet body 8 is provided with a second lens window 84, the upper chamber 83, and the upper rotating shaft cavity 82, wherein the upper rotating shaft cavity 82 and the upper chamber 83 are separated by a partition, and both the upper rotating shaft cavity 82 and the upper chamber 83 are communicated with the rotating shaft cavity C1.

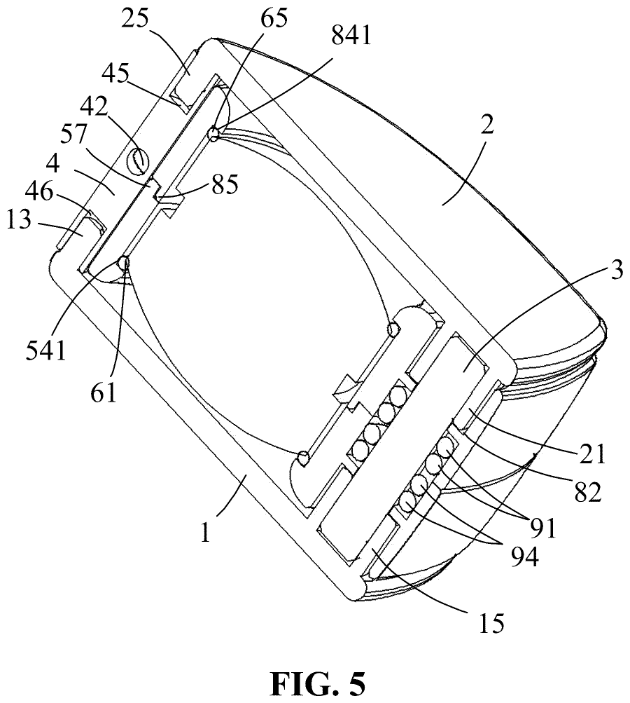

As shown in FIG. 5, the first sheet body 5 is provided with an outer positioning edge 57 at the top of the first lens window 54. The second sheet body 8 is provided with an inner positioning edge 85 at the bottom of the second lens window 84. The inner positioning edge 85 and the outer positioning edge 57 engage with each other.

In the embodiment, the lens 7 is a three-layer cemented lens, i.e., a magnifying lens.

Referring to FIG. 3 and FIG. 5, the first sheet body 5 is provided with a lower limiting shoulder 541 at a bottom edge of the first lens window 54, and a first vibration-attenuating ring 61 is disposed between the three-layer cemented lens 7 and the lower limiting shoulder 541. The second sheet body 8 is provided with an upper limiting shoulder 841 at a top edge of the second lens window 84, and a second vibration-attenuating ring 65 is disposed between the three-layer cemented lens 7 and the upper limiting shoulder 841. The first vibration-attenuating ring 61 and the second vibration-attenuating ring 65 have the functions of lens fixation, vibration attenuation, and lens protection.

Referring to FIG. 3 and FIG. 4 as well, in a tight-fit design of the holder A, the upper cover 2 is provided with a first shaft post 25 and a third shaft post 21, and the lower cover 1 is provided with a second shaft post 13 and a fourth shaft post 15. The third shaft post 21 is provided with a third interference hole 211. The fourth shaft post 15 is provided with a fourth interference hole 152.

During assembly, the rotating shaft 3 passes through the rotating shaft cavity C1 with one end of the rotating shaft 3 mounted in the third interference hole 211 of the third shaft post 21 in an interference fit manner. The other end of the rotating shaft 3 is mounted in the fourth interference hole 152 of the fourth shaft post 15 in an interference fit manner. For a lighter and smaller structural design, one end of the rotating shaft 3 and the third shaft post 21 in interference fit are jointly mounted in the upper rotating shaft cavity 82, and the other end of the rotating shaft 3 in the interference fit and the fourth shaft post 15 are together mounted in the lower rotating shaft cavity 51.

In the embodiment, a rotating damping feeling is created by interference, at least one of the upper chamber 83 or the lower chamber 52 of the accommodating cavity C2 is equipped with two or more damping members, and the above structure is applicable to a scenario with a low requirement for a damping feeling. It can be understood that in a scenario with a high requirement for the damping feeling, both the upper chamber 83 and the lower chamber 52 are equipped with two or more damping members, wherein such damping members are rubber rings. In the embodiment shown in FIG. 4, a pair of rubber rings 91 are mounted in the upper chamber 83, and a pair of rubber rings 94 are mounted in the lower chamber 52.

According to the damping feeling design requirements for a product, different numbers of damping members are used to create different rotating damping feelings by interference for the jewelry magnifier of the embodiment. When the magnifier assembly C is rotated out from or into the holder A, the damping for folding and rotating control is generated between the damping members 91, 94 and the rotating shaft 3 due to the friction force, to ensure that the magnifier assembly C can be folded tens of thousands of times without affecting the damping feeling while remaining unloosened, thus achieving durability and a better hand feeling during use.

As shown in FIG. 4 and FIG. 5, in the embodiment, the connecting post 4 is provided with a first interference hole 45 at the top and a second interference hole 46 at the bottom. The connecting shaft 4 is mounted together with the first shaft post 25 of the upper cover 2 in the interference fit manner through the first interference hole 45. The connecting shaft 4 is mounted together with the second shaft post 13 of the lower cover 1 in the interference fit manner through the second interference hole 46. The upper cover 2 and the lower cover 1 are assembled by using a bearing tight-fit structure, such that the upper and lower surfaces of the holder and the outer surface of the magnifier assembly are flat and smooth, and have a beautiful design and a good hand feeling.

In the embodiment, a clamping projection B is provided on the outer wall of the lens frame. A toggle groove B1 is recessed and provided in the middle of the clamping projection B, and the toggle groove B1 generates a good touch feeling when a user unfolds the magnifier assembly C. When the magnifier assembly C is folded and put back into the holder A, the clamping projection B is clamped and fixed to the connecting post 4, and the clamping projection B extends from the first sheet body 5 to the second sheet body 8.

In addition, a through hole 42 for a lanyard to pass through is provided in the connecting post 4 of the embodiment.

What is disclosed above is only a preferred embodiment of the present invention, and of course, it cannot be used to limit the scope of the claims of the present invention; therefore, equivalent changes made according to the claims of the present invention still fall within the scope of the present invention.

1. A jewelry magnifier, comprising:
a holder; and
a magnifier assembly rotatably stored in the holder,
wherein:
the holder comprises an upper cover and a lower cover,
the upper cover and the lower cover are tightly fitted and mounted by a connecting post and a rotating shaft,
the magnifier assembly comprises a lens and a lens frame,
a rotating shaft cavity is formed in the lens frame,
the rotating shaft is accommodated and mounted in the rotating shaft cavity to enable the magnifier assembly to be rotatably connected to the holder and buckled against the connecting post,
the lens frame is provided with an accommodating cavity surrounding the rotating shaft, and
at least one damping member is disposed in the accommodating cavity to generate required rotating damping between the damping member and the rotating shaft due to interference.

2. The jewelry magnifier according to claim 1, wherein:
the upper cover is provided with a first shaft post and a third shaft post,
the lower cover is provided with a second shaft post and a fourth shaft post;
the third shaft post is provided with a third interference hole,
the fourth shaft post is provided with a fourth interference hole, and
the rotating shaft passes through the rotating shaft cavity with one end thereof mounted in the third interference hole in an interference fit manner and the other end mounted in the fourth interference hole in the interference fit manner.

3. The jewelry magnifier according to claim 2, wherein:
the lens frame comprises a first sheet body and a second sheet body,
the rotating shaft cavity comprises an upper rotating shaft cavity and a lower rotating shaft cavity communicated with each other,
the accommodating cavity comprises an upper chamber and a lower chamber communicated with each other,
the first sheet body is provided with a first lens window, the lower rotating shaft cavity, and the lower chamber, and
the second sheet body is provided with a second lens window, the upper chamber, and the upper rotating shaft cavity.

4. The jewelry magnifier according to claim 3, wherein:
one end of the rotating shaft and the third shaft post in interference fit are jointly mounted in the upper rotating shaft cavity, and
the other end of the rotating shaft and the fourth shaft post in the interference fit are together mounted in the lower rotating shaft cavity.

5. The jewelry magnifier according to claim 3, wherein at least one of the upper chamber or the lower chamber of the accommodating cavity is equipped with two or more damping members;

6. The jewelry magnifier according to claim 3, wherein:
the first sheet body is provided with an outer positioning edge at the top of the first lens window,
the second sheet body is provided with an inner positioning edge at the bottom of the second lens window, and
the inner positioning edge and the outer positioning edge engage with each other.

7. The jewelry magnifier according to claim 3, wherein:
the lens is a three-layer cemented lens,
the first sheet body is provided with a lower limiting shoulder at a bottom edge of the first lens window,
a first vibration-attenuating ring is disposed between the three-layer cemented lens and the lower limiting shoulder,
the second sheet body is provided with an upper limiting shoulder at a top edge of the second lens window, and
a second vibration-attenuating ring is disposed between the three-layer cemented lens and the upper limiting shoulder.

8. The jewelry magnifier according to claim 1, wherein:
the connecting post is provided with a first interference hole at the top and a second interference hole at the bottom, and
the connecting shaft is mounted together with the first shaft post of the upper cover in the interference fit manner through the first interference hole and is mounted together with the second shaft post of the lower cover in the interference fit manner through the second interference hole.

9. The jewelry magnifier according to claim 3, wherein:
a clamping projection is provided on an outer wall of the lens frame, and
when the magnifier assembly is folded, the clamping projection is clamped and fixed with the connecting post; and the clamping projection extends from the first sheet body to the second sheet body.

10. A The jewelry magnifier, comprising:
a holder; and
a magnifier assembly rotatably stored in the holder,
wherein:
the holder comprises an upper cover and a lower cover,
the upper cover and the lower cover are tightly fitted and mounted by a connecting post and a rotating shaft,
the magnifier assembly comprises a lens and a lens frame,
a rotating shaft cavity is formed in the lens frame,
the rotating shaft is accommodated and mounted in the rotating shaft cavity to enable the magnifier assembly to be rotatably connected to the holder and buckled against the connecting post,
the lens frame is provided with an accommodating cavity surrounding the rotating shaft,
at least one damping member is disposed in the accommodating cavity to generate required rotating damping between the damping member and the rotating shaft due to interference
a through hole for a lanyard to pass through is provided in the connecting post.

11. The jewelry magnifier according to claim 1, wherein:
the upper cover is provided with a first shaft post and a third shaft post,
the lower cover is provided with a second shaft post and a fourth shaft post;
the third shaft post is provided with a third interference hole,
the fourth shaft post is provided with a fourth interference hole, and
the rotating shaft passes through the rotating shaft cavity with one end thereof mounted in the third interference hole in an interference fit manner and the other end mounted in the fourth interference hole in the interference fit manner.

12. The jewelry magnifier according to claim 11, wherein:
the lens frame comprises a first sheet body and a second sheet body,
the rotating shaft cavity comprises an upper rotating shaft cavity and a lower rotating shaft cavity communicated with each other,
the accommodating cavity comprises an upper chamber and a lower chamber communicated with each other,
the first sheet body is provided with a first lens window, the lower rotating shaft cavity, and the lower chamber, and
the second sheet body is provided with a second lens window, the upper chamber, and the upper rotating shaft cavity.

13. The jewelry magnifier according to claim 12, wherein:
one end of the rotating shaft and the third shaft post in interference fit are jointly mounted in the upper rotating shaft cavity, and
the other end of the rotating shaft and the fourth shaft post in the interference fit are together mounted in the lower rotating shaft cavity.

14. The jewelry magnifier according to claim 12, wherein at least one of the upper chamber or the lower chamber of the accommodating cavity is equipped with two or more damping members.

15. The jewelry magnifier according to claim 12, wherein both the upper chamber and the lower chamber are equipped with two or more damping members, wherein the damping members are rubber rings.

16. The jewelry magnifier according to claim 12, wherein:
the first sheet body is provided with an outer positioning edge at the top of the first lens window,
the second sheet body is provided with an inner positioning edge at the bottom of the second lens window, and
the inner positioning edge and the outer positioning edge engage with each other.

17. The jewelry magnifier according to claim 12, wherein: the lens is a three-layer cemented lens,
the first sheet body is provided with a lower limiting shoulder at a bottom edge of the first lens window,
a first vibration-attenuating ring is disposed between the three-layer cemented lens and the lower limiting shoulder,
the second sheet body is provided with an upper limiting shoulder at a top edge of the second lens window, and
a second vibration-attenuating ring is disposed between the three-layer cemented lens and the upper limiting shoulder.

18. The jewelry magnifier according to claim 12, wherein:
a clamping projection is provided on an outer wall of the lens frame, and
when the magnifier assembly is folded, the clamping projection is clamped and fixed with the connecting post; and the clamping projection extends from the first sheet body to the second sheet body.

19. The jewelry magnifier according to claim 11, wherein:
the connecting post is provided with a first interference hole at the top and a second interference hole at the bottom, and
the connecting shaft is mounted together with the first shaft post of the upper cover in the interference fit manner through the first interference hole and is mounted together with the second shaft post of the lower cover in the interference fit manner through the second interference hole.

20. The jewelry magnifier according to claim 3, wherein both the upper chamber and the lower chamber are equipped with two or more damping members, wherein the damping members are rubber rings.
